(19) United States
(12) Patent Application Publication
(10) Pub. No.: US 2024/0388076 A1
(43) Pub. Date: Nov. 21, 2024

(54) AUTOMATIC WINDING MODULE AND HIGHLY INTERCHANGEABLE CHARGING MODULE

(71) Applicant: ASAP TECHNOLOGY (JIANGXI) CO., LIMITED, Jiangxi Province (CN)

(72) Inventors: Li LI, Jiangxi Province (CN); Xiongwu LI, Jiangxi Province (CN); Jianjun TIAN, Jiangxi Province (CN)

(73) Assignee: ASAP TECHNOLOGY (JIANGXI) CO., LIMITED, Jiangxi Province (CN)

(21) Appl. No.: 18/216,950

(22) Filed: Jun. 30, 2023

(30) Foreign Application Priority Data
May 16, 2023 (CN) 202310548630.1

(51) Int. Cl. H02G 11/00; H02J 7/00

(52) U.S. Cl. CPC H02G 11/00; H02J 7/0042

(57) ABSTRACT

The present disclosure discloses an automatic winding module and a highly interchangeable charging module. In the automatic winding module, a winding assembly is disposed in the winding housing so that an output line may be wound in the winding housing. In this manner, any length can be extracted within the range of the total length of the output line when in use. A first connection assembly is configured to be detachably adsorptively connected to a power supply base output member. The power supply base output member has a second connection assembly. As long as a power supply base output member is provided with the second connection assembly, the power supply base output member may be connected to the automatic winding module having a first connection assembly. In this manner, the interchangeability between the automatic winding module and different categories of power supply base output members is implemented.

### CROSS-REFERENCE TO RELATED APPLICATIONS

This application claims priority to Chinese patent application No. 202310548630.1 filed with the China National Intellectual Property Administration (CNIPA) on May 16, 2023, the disclosure of which is incorporated herein by reference in its entirety.

### TECHNICAL FIELD

The present disclosure relates to the technical field of charging devices and, in particular, an automatic winding module and a highly interchangeable charging module.

### BACKGROUND

A power supply product currently on the market is basically designed with a separate power supply and a separate output line. Alternatively, the power supply product is designed with a direct connection line.

A conventional combination of a power supply and an output line generally meets people's living needs and is relatively convenient to carry. However, with a fixed length, the output line may be short or long when used, that is, the output line has a redundant length when a charging device is relatively close to a socket, or the output line is not long enough when the charging device is relatively far away from the socket. For this reason, it is difficult to have a proper length of the output line, or it is time-consuming and messy to store the output line. Moreover, the power supply needs to be plugged in or out to match with the socket every time the power supply is used, and the plugging process is affected by the quality of the socket. Since an elastic clip is disposed in the socket to grip a latch on the plug, repeated plugging in and out are prone to lead to a loosening of the combination of the latch and the elastic clip, thus causing the plug to easily fall from the socket and affecting the user experience.

The power supply product with a direct connection line has a relatively large overall volume, and the output line can be used only by being fixed to the existing power supply and cannot be used interchangeably.

Therefore, there is an urgent need to study an automatic winding module and a highly interchangeable charging module to avoid the following cases. The length of an output line is improper, the output line is difficult to store, a plug easily falls from a socket due to repeated plugging in and out between the plug and the socket, and the output line cannot be interchangeably used with other power supplies.

### SUMMARY

The present disclosure aims to provide an automatic winding module and a highly interchangeable charging module.

To achieve the preceding purposes, the present disclosure provides the technical schemes described below.

The present disclosure provides an automatic winding module. The automatic winding module includes a winding housing, a winding assembly, a first connection assembly, and a first charging assembly.

The winding assembly is disposed in the winding housing and is configured to wind an output line in the winding housing and enable the output line disposed outside the winding housing to stop at any length.

The first connection assembly is disposed in the winding housing and is configured to be detachably adsorptively connected to a power supply base output member having a second connection assembly.

The first charging assembly is disposed in the winding housing. The first charging assembly is configured to abut against and be electrically connected to a second charging assembly of the power supply base output member in a state in which the first connection assembly is adsorptively connected to the second connection assembly.

In an embodiment, an accommodation slot and a through hole communicating the accommodation slot with an inner cavity of the winding housing are disposed in the winding housing; the output line is disposed through the through hole and is wound around the winding assembly; and the accommodation slot is configured to accommodate a charging head of the output line.

In an embodiment, the first connection assembly includes a first magnetic attractive member disposed in the inner cavity of the winding housing.

In an embodiment, multiple first magnetic attractive members are provided and arranged in a ring shape.

In an embodiment, the first charging assembly includes a first positive electrode charging terminal and a first negative electrode charging terminal.

The present disclosure also provides a highly interchangeable charging module. The highly interchangeable charging module includes a power supply base output member and the automatic winding module in any of the preceding schemes. The power supply base output member includes a second connection assembly and a second charging assembly. The power supply base output member and the automatic winding module are detachably connected via the first connection assembly and the second connection assembly and are electrically connected via the first charging assembly and the second charging assembly.

In an embodiment, the power supply base output member includes a latch, one end of the latch is configured to be inserted into a receptacle of an electrical socket, and the other end of the latch is electrically connected to the second charging assembly.

In an embodiment, the power supply base output member includes a cable and at least one set of receptacles, one end of the cable is electrically connected to a power supply, and the other end of the cable is electrically connected to the at least one set of receptacles and the second charging assembly.

In an embodiment, the power supply base output member includes a storage battery, the output terminal of the storage battery is electrically connected to the second charging assembly, and the storage battery is rechargeable.

In an embodiment, the power supply base output member is provided with a docking slot in which the winding housing is configured to be matched and placed.

The present disclosure has the beneficial effects described below.

The present disclosure provides an automatic winding module. In the automatic winding module, a winding assembly is disposed in the winding housing so that an output line can be wound in the winding housing. In this manner, any length can be extracted within the range of the total length of the output line when in use, and thus the improper length of the output line and difficulty in storage are avoided. A first connection assembly is configured to be detachably adsorptively connected to a power supply base output member. The power supply base output member has a second connection assembly. The first charging assembly is configured to abut against and be electrically connected to a second charging assembly of the power supply base output member in a state in which the first connection assembly is adsorptively connected to the second connection assembly. The plugging in/out structure is replaced with the adsorptive structure so that repeated plugging operations of the power supply base output member are prevented, thereby avoiding the loosening of plugging assemblies. The adsorptive connection ensures the reliability of the connection between the automatic winding module and the power supply base output member. In addition, a power supply base output member, as long as provided with the second connection assembly, may be connected to the automatic winding module and can achieve an electrical connection via the first charging assembly and the second charging assembly. In this manner, the interchangeability between the automatic winding module and different categories of power supply base output members is implemented.

### BRIEF DESCRIPTION OF DRAWINGS

FIG. 1 is a view illustrating the structure of an automatic winding module according to embodiment one of the present disclosure.

FIG. 2 is a view illustrating the structure of a first connection assembly according to embodiment one of the present disclosure.

FIG. 3 is a view illustrating the structure of a power supply base output member according to embodiment two of the present disclosure.

FIG. 4 is a view illustrating the structure of a second connection assembly according to embodiment two of the present disclosure.

FIG. 5 is a view in which an automatic winding module cooperates with a power supply base output member according to embodiment two of the present disclosure.

FIG. 6 is a view illustrating the structure of a power supply base output member according to embodiment three of the present disclosure.

FIG. 7 is a view in which an automatic winding module cooperates with a power supply base output member according to embodiment three of the present disclosure.

FIG. 8 is a view illustrating the structure of a power supply base output member according to embodiment four of the present disclosure.

### REFERENCE LIST

100 automatic winding module
110 winding housing
111 accommodation slot
112 groove
120 first connection assembly
130 first charging assembly
131 first positive electrode charging terminal
132 first negative electrode charging terminal
133 first detection terminal
134 first full-charge detection terminal
140 output line
141 charging head
200 power supply base output member
201 base housing
210 second connection assembly
220 second charging assembly
221 second positive electrode charging terminal
222 second negative electrode charging terminal
223 second detection terminal
224 second full-charge detection terminal
225 protrusion
230 latch
240 cable
250 plug
260 docking slot
270 USB charging port
280 Type-C charging port
290 button

### DETAILED DESCRIPTION

The technical schemes of the present disclosure are described clearly and completely hereinafter in conjunction with drawings. Apparently, the described embodiments are part, not all, of embodiments of the present disclosure. Based on embodiments of the present disclosure, all other embodiments obtained by those of ordinary skill in the art without creative work are within the scope of the present disclosure.

In the description of the present disclosure, it is to be noted that orientations or position relations indicated by terms such as “center”, “upper”, “lower”, “left”, “right”, “vertical”, “horizontal”, “in”, and “out” are based on the drawings. These orientations or position relations are intended only to facilitate and simplify the description of the present disclosure and not to indicate or imply that an apparatus or element referred to must have such particular orientations or must be configured or operated in such particular orientations. Thus, these orientations or position relations are not to be construed as limiting the present disclosure. In addition, terms such as “first” and “second” are used only for the purpose of description and are not to be construed as indicating or implying relative importance. Terms “first position” and “second position” are two different positions. Moreover, when the first feature is described as “on”, “above”, or “over” the second feature, the first feature is right on, above, or over the second feature or the first feature is obliquely on, above, or over the second feature, or the first feature is simply at a higher level than the second feature. When the first feature is “under”, “below”, or “underneath” the second feature, the first feature is right under, below, or underneath the second feature, or the first feature is obliquely under, below, or underneath the second feature, or the first feature is simply at a lower level than the second feature.

In the description of the present disclosure, it is to be noted that unless otherwise expressly specified and limited, the term “mounted”, “connected to each other”, or “connected” should be construed in a broad sense as securely connected, detachably connected, or integrally connected; mechanically connected or electrically connected; directly connected to each other or indirectly connected to each other via an intermediary; or interconnected between two components. For those of ordinary skill in the art, specific meanings of the preceding terms in the present disclosure may be construed based on specific situations.

The embodiments of the present disclosure are described in detail below, and examples of the embodiments are illustrated in the drawings, where the same or similar reference numerals indicate the same or similar elements or elements having the same or similar functions. The embodiments described below with reference to the drawings are merely exemplary and intended to explain the present disclosure, and are not to be construed as limiting the present disclosure.

### Embodiment One

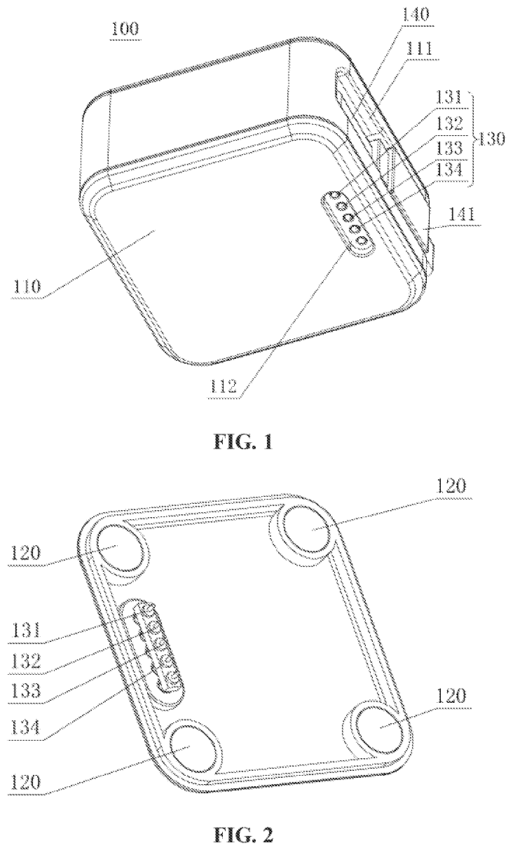

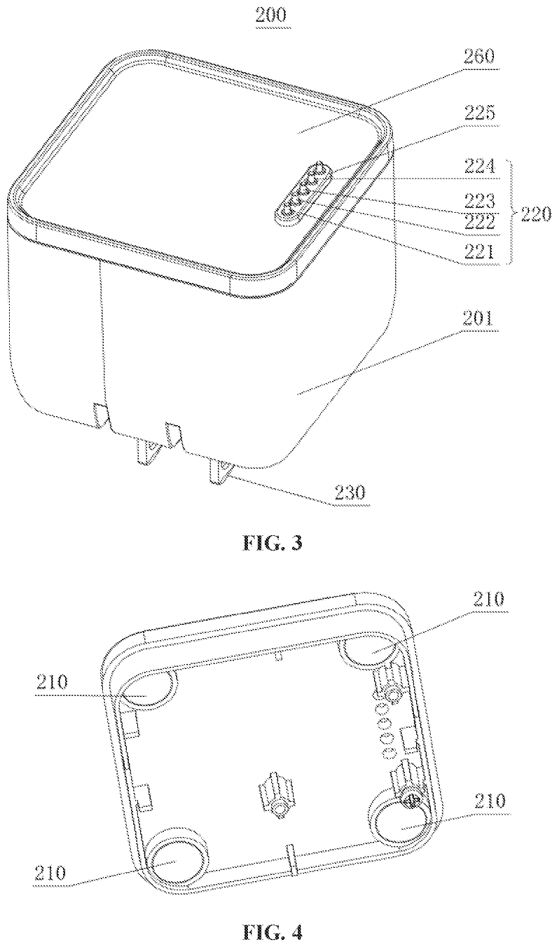

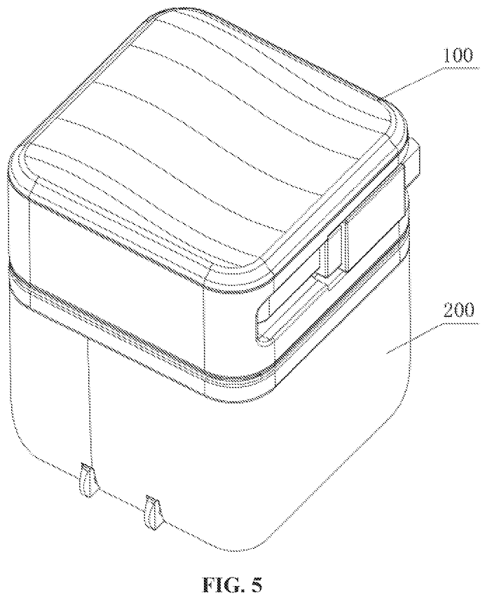

As shown in FIGS. 1 to 5, this embodiment provides an automatic winding module. The automatic winding module includes a winding housing 110, a winding assembly (not shown in the figures), a first connection assembly 120, and a first charging assembly 130. The winding assembly is disposed in the winding housing 110 and is configured to wind an output line 140 in the winding housing 110 and enable the output line 140 disposed outside the winding housing 110 to stop at any length. The output terminal of the output line 140 may be connected to a charging port of a charging device. The charging device may be an electronic device that needs to be charged, such as a mobile phone, a tablet computer, or a computer. The first connection assembly 120 is disposed in the winding housing 110 and is configured to be detachably adsorptively connected to a power supply base output member 200 having a second connection assembly 210. In other words, the power supply base output member 200 has a second connection assembly 210, and the power supply base output member 200 is detachably adsorptively connected to the automatic winding module 100 via the first connection assembly 120 and the second connection assembly 210. The first charging assembly 130 is disposed in the winding housing 110. The first charging assembly 130 is configured to abut against and be electrically connected to a second charging assembly 220 of the power supply base output member 200 in a state in which the first connection assembly 120 is adsorptively connected to the second connection assembly 210.

It should be noted that the structure of the winding assembly and the method of winding the output line 140 are well-known to those skilled in the art. To save space, details are not described herein.

In the automatic winding module 100, the winding assembly is disposed in the winding housing 110 so that the output line 140 can be wound in the winding housing 110. In this manner, any length can be extracted within the range of the total length of the output line 140 when in use, and thus the improper length of the output line 140 and difficulty in storage are avoided. The first connection assembly 120 is configured to be detachably adsorptively connected to the power supply base output member 200 has the second connection assembly. The first charging assembly 130 is configured to abut against and be electrically connected to the second charging assembly 220 of the power supply base output member 200 in a state in which the first connection assembly 120 is adsorptively connected to the second connection assembly 210. The plugging structure is replaced with the adsorptive structure so that the repeated plugging operations of the power supply base output member 200 are prevented, thereby avoiding the loosening of plugging assemblies. The adsorptive connection ensures the reliability of the connection between the automatic winding module 100 and the power supply base output member 200. In addition, as long as a power supply base output member 200 is provided with the second connection assembly 210, the power supply base output member 200 may be connected to the automatic winding module 100 and can achieve an electrical connection via the first charging assembly 130 and the second charging assembly 220. In this manner, the interchangeability between the automatic winding module 100 and different categories of power supply base output members 200 is implemented.

An accommodation slot 111 is disposed at the outer circumference of the winding housing 110. A through hole communicating the accommodation slot 111 with the inner cavity of the winding housing 110 is disposed in the winding housing 110. The output line 140 is disposed through the through hole and is wound around the winding assembly. The accommodation slot 111 is configured to accommodate a charging head 141 of the output line 140. The configuration of the accommodation slot 111 enables the output line 140 to be stored more accurately.

The inner cavity of the winding housing 110 is provided with a magnet. The charging head 141 of the output line 140 is at least partially made of magnetic attractive material. The charging head 141 of the output line 140 which is located in the accommodation slot 111 is capable of being adsorbed by the magnet.

With respect to the first connection assembly 120, in this embodiment, the first connection assembly 120 includes a first magnetic attractive member disposed in the inner cavity of the winding housing 110. In this embodiment, the second connection assembly 210 may be a second magnetic attractive member or be made of magnetic attractive material.

In other embodiments, the first connection assembly 120 may be made of magnetic attractive material, and the second connection assembly 210 may be a magnetic attractive member.

The first magnetic attractive member is a permanent magnet. The second magnetic attractive member is a permanent magnet. The magnetic attractive material is stainless steel or iron.

To achieve a stable connection between the automatic winding module 100 and the power supply base output member 200, multiple first magnetic attractive members are provided in this embodiment and arranged in a ring shape. In this embodiment, the second connection assembly 210 may be a second magnetic attractive member, and multiple second magnetic attractive members are provided and arranged in a ring shape. The multiple second magnetic attractive members are in a one-to-one correspondence to the multiple first magnetic attractive members.

Four first magnetic attractive members and four second magnetic attractive members are provided. The four first magnetic attractive members are disposed at the four corners of the winding housing 110. The magnetic poles of three of the four first magnetic attractive members involved in adsorption are the N pole, and the magnetic pole of the other first magnetic attractive member involved in adsorption is the S pole. The four second magnetic attractive members are disposed at the four corners of the power supply base output member 200. The magnetic poles of three of the four second magnetic attractive members involved in adsorption are the S pole, and the magnetic pole of the other second magnetic attractive member involved in adsorption is the N pole. That is, among the four first magnetic attractive members, three of them have the N pole facing outward and the other has the S pole facing outward; among the four second magnetic attractive members, three of them have the S pole facing outward and the one has the N pole facing outward. This configuration ensures a relative angle between the automatic winding module 100 and the power supply base output member 200 when the two are in adsorption, thereby ensuring the accuracy of the electrical connection.

The first charging assembly 130 includes a first positive electrode charging terminal 131 and a first negative electrode charging terminal 132. The second charging assembly 220 includes a second positive electrode charging terminal 221 and a second negative electrode charging terminal 222. In other embodiments, the first charging assembly 130 and the second charging assembly 220 may be wireless charging assemblies.

The first charging assembly 130 also includes a first detection terminal 133 configured to detect whether the first charging assembly 130 and the second charging assembly 220 are communicated. When the first charging assembly 130 and the second charging assembly 220 are communicated, the circuit of the second charging assembly 220 is turned on. In an embodiment, the first positive electrode charging terminal 131, the first negative electrode charging terminal 132, and the first detection terminal 133 are arranged side-by-side and spaced from one another. The second charging assembly 220 also includes a second detection terminal 223. The second positive electrode charging terminal 221, the second negative electrode charging terminal 222, and the second detection terminal 223 are arranged side-by-side and spaced from one another. After the automatic winding module 100 is docked with the power supply base output member 200, and the first detection terminal 133 and the second detection terminal 223 are communicated, the circuit of the second charging assembly 220 is turned on. The preceding configuration improves the safety performance of charging.

The first charging assembly 130 also includes a first full-charge detection terminal 134 configured to detect whether the charging device is fully charged. When the charging device is fully charged, the circuit of the second charging assembly 220 is turned off. In an embodiment, the second charging assembly 220 also includes a second full-charge detection terminal 224. After the charging device is fully charged, a signal is transmitted to the power supply base output member 200 via the first full-charge detection terminal 134 and the second full-charge detection terminal 224, and the circuit of the second charging assembly 220 is turned off. It should be noted that the power supply base output member 200 has a controller, and the working principle of the controller that the second charging assembly 220 is controlled to be turned on or off is well known to those skilled in the art. To save space, details are not described herein. In other embodiments, information that the charging device is fully charged may be transmitted to the power supply base output member 200 in a wireless manner or other manners.

In other embodiments, two first positive electrode charging terminals 131 and two first negative electrode charging terminals 132 may be provided, and two second positive electrode charging terminals 221 and two second negative electrode charging terminals 222 may be provided so as to improve the reliability of docking.

In this embodiment, the winding housing 110 is provided with a groove 112 at which the first charging assembly 130 is located. The power supply base output member 200 is provided with a protrusion 225 capable of being clamped in the groove 112. Multiple holes are disposed in the protrusion 225, and each terminal of the second charging assembly 220 is disposed in a respective hole in a one-to-one correspondence. Each terminal of the second charging assembly 220 is a telescopic terminal.

### Embodiment Two

As shown in FIGS. 1 to 5, this embodiment also provides a highly interchangeable charging module. The highly interchangeable charging module includes a power supply base output member 200 and the automatic winding module 100 in the preceding schemes. The power supply base output member 200 includes a second connection assembly 210 and a second charging assembly 220. The power supply base output member 200 and the automatic winding module 100 are detachably connected via the first connection assembly 120 and the second connection assembly 210 and are electrically connected via the first charging assembly 130 and the second charging assembly 220. The structures of the second connection assembly 210 and the second charging assembly 220 are referred to the content described in embodiment one.

In an embodiment, the power supply base output member 200 is also provided with a universal serial bus (USB) charging port 270. In an embodiment, the power supply base output member 200 is also provided with a Type-C charging port 280. In an embodiment, the power supply base output member 200 is also provided with a USB charging port 270 and a Type-C charging port 280.

Furthermore, the power supply base output member 200 is provided with a docking slot 260 in which the winding housing 110 is matched and placed. This configuration facilitates a stable connection between the automatic winding module 100 and the power supply base output member 200 and avoids a relative slide between the automatic winding module 100 and the power supply base output member 200 in the direction perpendicular to the axis of the docking slot 260, thereby ensuring the safety of the first charging assembly 130 and the second charging assembly 220.

The power supply base output member 200 includes a latch 230. One end of the latch 230 is capable of being inserted into a receptacle of an electrical socket. The other end of the latch 230 is electrically connected to the second charging assembly 220. In this embodiment, the electrical socket may be configured on the wall. In this embodiment, the power supply base output member 200 may also be called a wall charging module.

The power supply base output member 200 includes a base housing 201 in which the second connection assembly 210 and the second charging assembly 220 are disposed. The second connection assembly 210 is disposed in the inner cavity of the base housing 201. A USB charging port 270 may be disposed in the base housing 201. A Type-C charging port 280 may be disposed in the base housing 201. The docking slot 260 is disposed in the base housing 201. The opening size of the docking slot 260 increases gradually in the direction away from the bottom of the docking slot 260. The protrusion 225 is located at the bottom of the docking slot 260. The latch 230 is disposed in the base housing 201.

### Embodiment Three

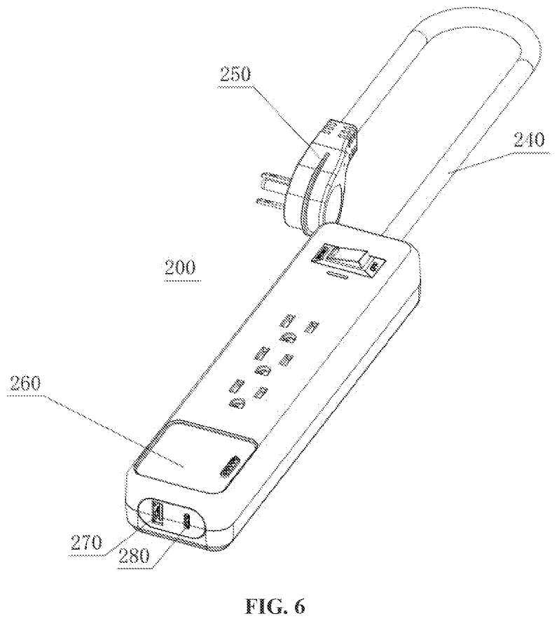

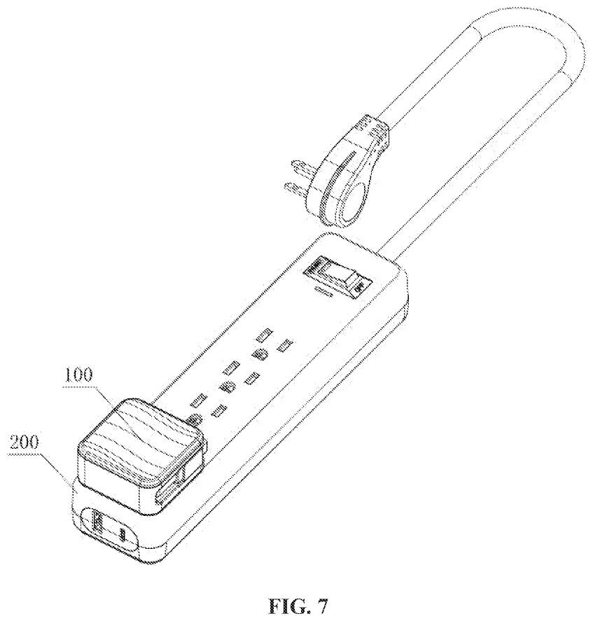

In conjunction with FIGS. 6 and 7, this embodiment also provides a highly interchangeable charging module that has roughly the same structure as that of embodiment two, except that the power supply base output member 200 includes a cable 240 and at least one set of receptacles. One end of the cable 240 is electrically connected to a power supply, that is, one end of the cable 240 is electrically connected to the mains supply. The other end of the cable 240 is electrically connected to both the at least one set of receptacles and the second charging assembly 220. One end of the cable 240 may be connected to a plug 250, and the plug 250 includes a handle and a latch 230. One end of the latch 230 is connected to the cable 240, and the other end may be plugged into a receptacle of an electrical socket. In this embodiment, the power supply base output member 200 may also be called a socket module.

### Embodiment Four

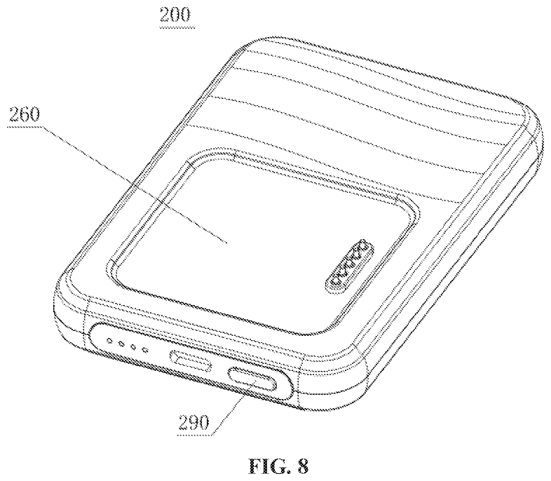

In conjunction with FIG. 8, this embodiment also provides a highly interchangeable charging module that has roughly the same structure as that of embodiment two, except that the power supply base output member 200 includes a storage battery. The output terminal of the storage battery is electrically connected to the second charging assembly 220. The storage battery is rechargeable. In this embodiment, the power supply base output member 200 includes a button 290 capable of controlling the second charging assembly 220 to be connected or disconnected to the storage battery. In this embodiment, the power supply base output member 200 may also be called a power bank module.

Apparently, the preceding embodiments of the present disclosure are only illustrative of the present disclosure and are not intended to limit the implementations of the present disclosure. For those of ordinary skill in the art, changes or alterations in other different forms may also be made based on the preceding description. All implementations cannot be and do not need to be exhausted herein. Any modifications, equivalent substitutions, and improvements made within the spirit and principle of the present disclosure fall within the scope of the claims of the present disclosure.

What is claimed is:

1. An automatic winding module, comprising:
a winding housing;
a winding assembly disposed in the winding housing, wherein the winding assembly is configured to wind an output line in the winding housing and enable the output line disposed outside the winding housing to stop at any length;
a first connection assembly disposed in the winding housing, wherein the first connection assembly is configured to be detachably adsorptively connected to a power supply base output member having a second connection assembly; and
a first charging assembly disposed in the winding housing, wherein the first charging assembly is configured to abut against and be electrically connected to a second charging assembly of the power supply base output member in a state in which the first connection assembly is adsorptively connected to the second connection assembly.

2. The automatic winding module of claim 1, wherein an accommodation slot and a through hole communicating the accommodation slot with an inner cavity of the winding housing are disposed in the winding housing, the output line is disposed through the through hole and is wound around the winding assembly, and the accommodation slot is configured to accommodate a charging head of the output line.

3. The automatic winding module of claim 1, wherein the first connection assembly comprises a first magnetic attractive member disposed in an inner cavity of the winding housing.

4. The automatic winding module of claim 3, wherein a plurality of first magnetic attractive members are provided and arranged in a ring shape.

5. The automatic winding module of claim 1, wherein the first charging assembly comprises a first positive electrode charging terminal and a first negative electrode charging terminal.

6. A highly interchangeable charging module, comprising a power supply base output member and an automatic winding module, wherein the automatic winding module comprises a winding housing, a winding assembly, a first connection assembly, and a first charging assembly; wherein the winding assembly is disposed in the winding housing and is configured to wind an output line in the winding housing and enable the output line disposed outside the winding housing to stop at any length; the first connection assembly is disposed in the winding housing and is configured to be detachably adsorptively connected to a power supply base output member having a second connection assembly; and the first charging assembly is disposed in the winding housing and is configured to abut against and be electrically connected to a second charging assembly of the power supply base output member in a state in which the first connection assembly is adsorptively connected to the second connection assembly; and
wherein the power supply base output member comprises the second connection assembly and the second charging assembly, and the power supply base output member and the automatic winding module are detachably connected via the first connection assembly and the second connection assembly and are electrically connected via the first charging assembly and the second charging assembly.

7. The highly interchangeable charging module of claim 6, wherein the power supply base output member comprises a latch, one end of the latch is inserted into a receptacle of an electrical socket, and another end of the latch is electrically connected to the second charging assembly.

8. The highly interchangeable charging module of claim 6, wherein the power supply base output member comprises a cable and at least one set of receptacles, one end of the cable is electrically connected to a power supply, and another end of the cable is electrically connected to the at least one set of receptacles and the second charging assembly.

9. The highly interchangeable charging module of claim 6, wherein the power supply base output member comprises a storage battery, an output terminal of the storage battery is electrically connected to the second charging assembly, and the storage battery is a rechargeable battery.

10. The highly interchangeable charging module of claim 6, wherein the power supply base output member is provided with a docking slot, and the winding housing is capable of being matched and arranged in the docking slot.

11. The highly interchangeable charging module of claim 7, wherein the power supply base output member is provided with a docking slot, and the winding housing is capable of being matched and arranged in the docking slot.

12. The highly interchangeable charging module of claim 8, wherein the power supply base output member is provided with a docking slot, and the winding housing is capable of being matched and arranged in the docking slot.

13. The highly interchangeable charging module of claim 9, wherein the power supply base output member is provided with a docking slot, and the winding housing is capable of being matched and arranged in the docking slot.

14. The highly interchangeable charging module of claim 6, wherein an accommodation slot and a through hole communicating the accommodation slot with an inner cavity of the winding housing are disposed in the winding housing, the output line is disposed through the through hole and is wound around the winding assembly, and the accommodation slot is configured to accommodate a charging head of the output line.

15. The highly interchangeable charging module of claim 6, wherein the first connection assembly comprises a first magnetic attractive member disposed in an inner cavity of the winding housing.

16. The highly interchangeable charging module of claim 15, wherein a plurality of first magnetic attractive members are provided and arranged in a ring shape.

17. The highly interchangeable charging module of claim 6, wherein the first charging assembly comprises a first positive electrode charging terminal and a first negative electrode charging terminal.
